(19) United States
(12) Patent Application Publication
(10) Pub. No.: US 2013/0081711 A1
(43) Pub. Date: Apr. 4, 2013

(54) Dish washer hand saver

(71) Applicant: John J. Russo, Secaucus, NJ (US)

(72) Inventor: John J. Russo, Secaucus, NJ (US)

(21) Appl. No.: 12/803,416

(22) Filed: Sep. 17, 2010

(51) Int. Cl. F16K 13/00

(52) U.S. Cl. CPC F16K 13/00
USPC 137/315.01

(57) ABSTRACT

The Dish Washer Hand Saver is a fluid control device. This device is threaded on each end. The top of the device is attached via a swivel nut with the threads of the nut exposed. This end is to be attached to the water source. The device has a control knob on the side. This knob controls turns, thus allowing the flow or not of the fluid at the desired volume. The bottom end of the device has interior threads on its end to accept a standard kitchen sink aerator.

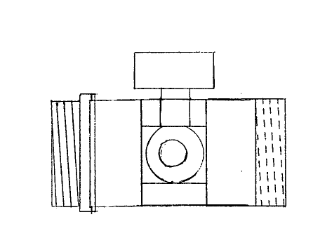

The Dish Washer Hand Saver is a fluid control device. The device is threaded on each end. The top is threaded with a swivel nut with the threaded portion exposed. This exposed male threaded end would be threaded into a female threaded end of whatever device/hook up The Dish Washer Hand Saver is being attached to, typically a standard kitchen sink faucet. The device opens and closes, via a control knob on the exterior side of the device. This control knob, which controls the opening and or closing of a ball valve internally in the device, allows fluid to pass. The control knob operates on a 180-degree open/closed/open positioning. The 3 positions of the control valve allow the device to be operated efficiently with either hand depending upon how the device is mounted, via the swivel nut. The swivel nut on the top of the device allows the device to be positioned on a 360-degree axis when installed. The bottom end of the device is a threaded female end. This end would typically accept a standard kitchen sink aerator. The ideal use of The Dish Washer Hand Saver is attaching it to the faucet of a kitchen sink that utilizes, but not limited to, separate hot and cold-water controls. Once the desired water temperature is achieved, the proper hot and cold water mix, The Dish Washer Hand Saver device is used to turn on and off the water instead of the sink's faucets. The device will save time by not having to constantly turn the water on and off via the faucets while washing, it greatly reduces the potential for scalds due to an improper mix of hot and cold water since the desired water temperature has already been set, and it will save money since many people just let the water run while washing in the kitchen sink. Just a quick flip of the 3-position control valve on the device allows a steady stream of the desired water temperature to flow.

The substitute specifications contains no new matter. There is no substitute specification since there were no substitute specifications ever submitted on the claim.

The embodiments of the invention in which an exclusive property or privelege is claimed are defined as follows:

1. The Dish Washer Hand Saver is a fluid control devise that is attached to any a tube, pipe, conduit, line, or any other devise, item, substance, or vessel that is used to convey water, oil, gas, or other fluid substance.

2. The devise, in claim 1, comprising of: a swivel threaded nut on the top of the device, threaded on the bottom end, and control knob on the side of the devise.

3. The devise, in claim 1 and claim 2; utilizes a swivel nut with exterior threads on the top of the devise meant, as a means for attachment to a fluid delivery component, such as but not limited to a kitchen sink faucet, as well as a means that allows the positioning of the devise on a 360 degree vertical axis for ease of use, the bottom end which has interior threads on the devise is meant to receive a device to aid in the fluid flow, such as a sink aerator or the like, in the case of the devise being used to control the flow of water, if required, but not necessary for the operation of the device, a control knob is located on the side of the devise that controls a ball valve located in the interior or center of the devise which operates on a 180 degree axis allowing the open, closed, and open positioning of the valve to allow the flow of fluid.
